(19) United States
(12) Patent Application Publication
(10) Pub. No.: US 2008/0201423 A1
(43) Pub. Date: Aug. 21, 2008

(54) Multisensorial Communication Method Between Services and Remote Users and System Architecture for Actuating It

(75) Inventors: Massimo Bergamasco, Castelmaggiore (IT); Carlo Alberto Avizzano, Pisa (IT); Mirko Raspolli, Bibbona (IT); Emanuele Ruffaldi, Porto Ercole (IT)

Correspondence Address: DENNISON, SCHULTZ & MACDONALD, 1727 KING STREET, SUITE 105, ALEXANDRIA, VA, 22314, US

(73) Assignee: SCUOLA SUPERIORE DI STUDI UNIVERSITARE S. ANNA, Pisa (IT)

(21) Appl. No.: 11/916,857

(22) PCT Filed: Jun. 12, 2006
(86) PCT No.: PCT/IB06/01573

§ 371 Date: Dec. 18, 2007

(30) Foreign Application Priority Data
Jun. 10, 2005 (IT) PI 2005A000062

(51) Int. Cl. G06F 3/00; G06F 15/16

(52) U.S. Cl. 709/204

(57) ABSTRACT

A communication method between one or more users (20 and 40) associated to respective workstations and one or more remote services (26) located in different geographic places connected by a communication network (21), capable of establishing a direct connection between a remote service agent (31) and an interface agent (28 and 43) in real time, creating a common immersive virtual environment to the users where said services are available and where said users (20 and 40) can cooperate in real time—According to this method, an user (20) comes into contact with a physic interface device (21), for example a haptic interface capable of transmitting to the user feedback signals making a virtual environment in which the user has the sensation to be immersed, connected to an interface agent (28) adapted to connect said physic interface device (21) with a connection network (27). The interface agent (23) is capable of analysing signals corresponding to the sensorial perception channels of the user, for example visual (28), haptic (29) and audio (30) channels. A second user (40), through a second haptic interface can connect to the same service (26) by an interface agent (43) entering in the same virtual environment of the first user (20), with which he can cooperate. The interface and service agents can generate local models (50 and 51) that are easily transmittable.

### FIELD OF THE INVENTION

The present invention relates to a communication method in real time between one or more individuals or users, also arranged remotely to one another, and one or more services also delocalized geographically with respect to the individuals.

The following can be possible applications: physic modeling of objects and virtual reality systems, simulation of the behaviour of physical/chemical elements, simulation of structures and mechanisms described with finite elements methods, support to quick prototyping of objects by means of techniques of remote cooperation/verification, the use of remote and/or distributed virtual environments for teaching and for executing particular manual activities, as well as all situations in which a multisensorial cooperation in real time between remote users is required.

### DESCRIPTION OF THE TECHNICAL PROBLEM

Many types of virtual environment services are known. They consist, normally, in an application software, arranged at one or several stations, capable of generating and managing the digital data relative to a computer simulation of either an environment or a mathematically modeled system. The display of said data is made through the generation of a returning signal towards the user capable of stimulating one or more sensorial perception channels of the user, for example hearing, sight, touch, smell.

Such a service is presently provided only locally, on special workstations having suitable interfaces connected to computers.

In the field of interactive communication between an user and either another remote user or a remote service, various types of architectures are known.

For example, teleoperation is known providing normally a remote tool installed in a slave station, a communication channel between a master station and the slave station and an interface device with the user, controlled by a second control software and installed in the master station. Since a direct channel is used between master and slave, and not a network, coding the transmitted signals is not necessary.

A drawback of the teleoperation architectures is that a same remote instrument cannot be operated by several remote users connected to one another in a network, thus banning a cooperation in real time of more users in a same virtual environment.

A further drawback of the known teleoperation architectures is that a returning signal is not of multisensorial type, since normally only a simple feedback force is provided to the user in combination to a video signal for monitoring the actions.

On the other hand, common communication systems exist between one or more users and a remote service consisting allowing to browse a remote database, where the database is to be considered a service. In particular, in the present case the element for controlling the system comprises a personal computer connected through a network and operated by a user, whereas the controlled element (the service) comprises a remote network server. A typical example of architecture for browsing a remote database comprises:
an access program in the control station, for example a network browser;
a communication network between the components;
a software agent capable of interfacing the software present in the control computer, for example a browser, with the communication protocols supportable by the network services;
a service installed on the remote server, for example the database;
a service software agent on the server, adapted to analyze the protocols produced by the agent at the control station and to generate, in consequence, the suitable requests of control for the database, able to interpret the results and to give the output thus computed to the remote control service.

An advantage of an architecture of interactive communication between an user and a remote service, as just described, is given by the fact that more users also remote to each other, can communicate at the same time with a same remote service. For example, they can make different contemporary queries to a same database and can obtain each the predetermined result.

A drawback of this architecture of interactive communication is the fact that it does not act in real time, since the user receives the returning signal with a delay according to the latency and to the amplitude of the band associated to the specific connection network. In fact, when the user runs a query, it is computed locally by the browser and then it is sent to the service agent through the network, so that the service agent computes the data of the service and sends them to the user through the network. Therefore, this transmission accumulates delays according to the control time required by the interface agent and by the rate of use of network transmission band.

Therefore, none of the existing architectures is able to support mechanisms of bidirectional communication suitable for representing in real time the multisensorial data necessary for implementing the typical concepts of presence of the virtual environments above described.

Therefore, there is the need to provide a method of communication between one or more users with one or more remote services even if they are located in different geographically places, having at the same time the advantages described for providing multisensorial data in real time associated with different interface and services, thus allowing the remote communication and cooperation in the same virtual environment.

### SUMMARY OF THE INVENTION

It is therefore a feature of the present invention to provide a communication method between one or more users and one or more remote services even located in geographically different places, capable of allowing communication in real time between such users and such services, in a common virtual environment where all the users and all the services are present, wherein the users, while communicating with the services, can cooperate with each other even if being physically distant.

Another feature of the present invention is to provide a communication method between one or more users and one or more remote services, capable of creating, in a multisensorial virtual environment and shared between the above described users, a mechanism of perception of the data in real time in turn capable of supporting the cooperation among users and the control of remote services and resources.

A further feature of the present invention is to provide a communication method between one or more users and one or more remote services even located in geographically different places, which does not need knowledge and or manual installation of a software for accessing and/or controlling a service, so that such service is usable from a desired remote location and in the presence of a plurality of means for representing virtual environments.

Another feature of the present invention is to provide a communication method between one or more users and one or more remote services even located in geographically different places, wherein it is not necessary to purchase a service and to install it locally, but it is sufficient to pay-per-use it remotely and in real time.

It is another feature of the invention to provide a system architecture capable of carrying out the above described method.

These and other objects are achieved by a communication method between one or more users associated to respective workstations and one or more remote services even located in geographically different places, said workstations and said services being connectable by a communication network, comprising the steps of:
providing a remote service located in a Web server or distributed among more Web servers;
providing an interface device between said user and a relative local workstation;
connecting said local workstation with said or each Web server through a communication network;
   characterized in that said step of connecting comprises the steps of:
creating on said or each Web server an interface agent between said device and the communication network, said interface agent computing signals corresponding to sensorial perception channels of the user comprising the haptic, visual and audio channels;
uploading said interface agent in said local workstation;
creating on said or each Web server a service agent adapted to connect said service with said communication network, said service agent computing signals corresponding to sensorial perception channels of the user comprising the haptic, visual and audio channels;
connecting in an automatic and direct way said interface agent and said service agent and activating a common immersive virtual environment in which said or each user can work.

This way a direct connection is operatively established between said remote service agent and said interface agent in real time making a common immersive virtual environment for said users, where said services are available to them and where said users can cooperate in real time. Furthermore, said step of connecting in an automatic and direct way said remote service agent and said interface agent has a data flow, so that the quality of the service depends on the means for connecting.

In particular, said haptic channel provides to the user a signal with frequency not less than 1 kHz.

In particular, said visual channel provides to the user a signal with frequency not less than 20 Hz.

In particular, said interface device is capable of providing to the user data of afferent and/or efferent type.

Advantageously, said service agent and said interface agent are capable of generating a respective model of local behaviour directly transmissible in real time between said agents through said connection. This model of local behaviour can be for example a control of data for representation of the sensorial signals in real time even in absence/delay of the data coming from the remote server.

In particulars said communication network comprises connecting means selected from the group comprised of:
cable;
air;
satellite.

In particular, said services comprise a software capable of generating digital data relative to said sensorial perception channels, said services being selected from the group comprised of:
solid and/or geometric modeling;
interaction with stiff or deformable physical objects;
modeling mechanisms and mechanical behaviours;
modeling physical phenomena such as field forces of electric, magnetic, chemical fields.
modeling/reproducing processes consisting of simple or articulated sequences of motion and procedures.
remote training courses.

According to another aspect of the invention, these and other objects are achieved by a system communication architecture between one or more users associated to respective workstations and one or more remote services even located in geographically different places, comprising:
a physical interface device between said user and said local workstation;
connection means;
an interface agent adapted to connect said physical interface device with said connection means;
a remote service agent adapted to connect said remote service with said connection means;
   whereby a direct connection is operatively established between said remote service agent and said interface agent, adapted to act in real time and to create a common immersive virtual environment to said users where said services are available and where said users can cooperate in real time.

### BRIEF DESCRIPTION OF THE DRAWINGS

The invention will be made clearer with the following description of an exemplary embodiment thereof, exemplifying but not limitative, with reference to the attached drawings wherein:

FIG. 1 shows diagrammatically the context where it is located the proposed system;

FIG. 2 shows a block diagram of a scenario that describes the possibility of interacting in a common virtual environment where the users can share at the same time the services;

FIG. 3 shows a block diagram of an acoustic scenario that describes the possibility of interaction between the users and the services;

FIG. 4 shows a block diagram of a haptic scenario where the data of movement, of force and tactile data exchanged through the interface devices at the users allow a bidirectional data flow;

FIG. 5 shows a block diagram of the method where the interface agent and the service agent generate local models;

FIG. 6 shows such a block diagram where a second user is connected to a same service;

FIG. 7 shows the example of a possible scenario of application of the method;

FIG. 8 shows a diagrammatical view of the interaction between two users by the multisensorial system pursuant to the method according to the invention.

### DESCRIPTION OF PREFERRED EXEMPLARY EMBODIMENTS

According to the present invention, a communication method between one or more users, which are associated to respective workstations, and one or more remote services, even located in geographically different places, is capable of establishing a direct connection between a remote service agent and an interface agent adapted to act in real time and to create a common immersive virtual environment to said users where said services are available and where said users can cooperate in real time. Furthermore, the present invention relates to a system architecture capable of carrying out this method.

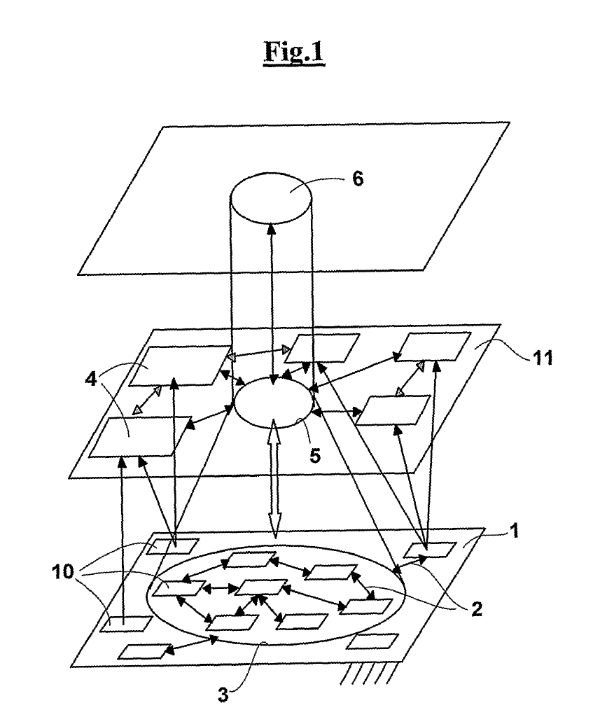

In FIG. 1 a context is shown where the proposed method can be developed. This context comprises an interconnection network that extends mainly on three plane dimensions, where the physical or real plane 1 comprises a plurality of users 10, for example search entities or other entities that have a real size and a fixed space. In this plane dimension 1 the relationships and the links 2 are shown between the many users or entities 10. Such links 2 between the users of the system can be intense, thus defining a community 3 that is an subset of the physical plane dimension 1, this community 3 in any case maintains the links 2 even with users or entities 10 external with respect to this community 3 and in any case belonging to the physical plane dimension 1.

Each user 10 of the physical plane 1 has an image 4 projected on the web plane dimension 11, which is identified by a corresponding website 4. The community 3 of the physical plane 1 has a reference website image 5 common to all the users within this community 3.

The website 5 is the instrument by which the community 3 of the physical plane 1 accede to plane virtual dimension 6.

The physical resources and operators identifiable with the users 10 of the physical plane 1, the possible tests, and applications obtainable in virtual environment 6 are accessible by the web level 11 for planning and for a not immersive access to the data.

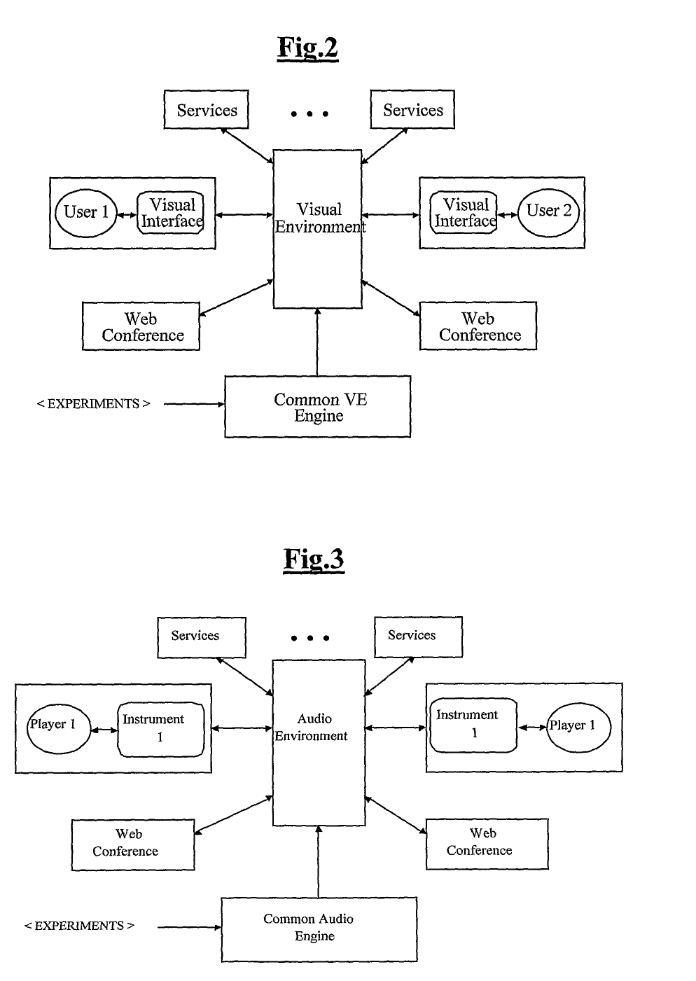

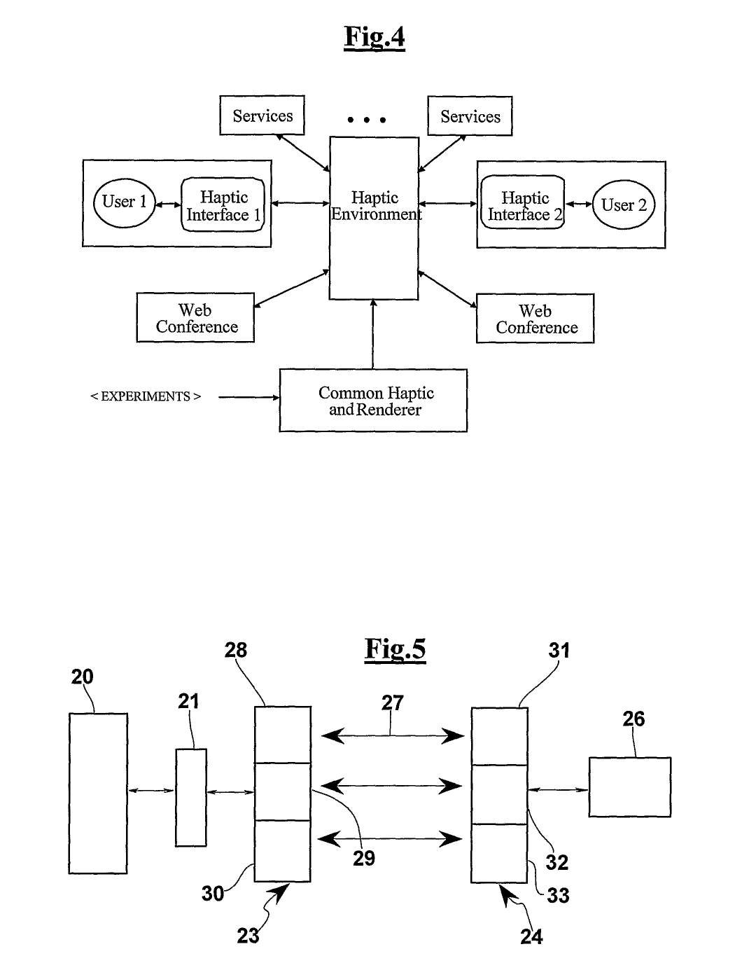

Owing to its high flexibility in the configuration, the method according to the invention can approach different scenarios corresponding to sensorial perception channels of the user, such as the three visible, acoustic and haptic channels used for interoperation or any combination thereof. In FIGS. 2, 3 and 4 the features of the interaction respectively relating to the visible, audio, tactile and haptic channels are described without showing the obvious potentiality offered by the combination of the same.

All the above described scenarios provide the interaction between two or more users at remote workstations, by the mediation of a server capable of offering and centralizing a plurality of services available locally or through the network by the scheme shown in FIG. 1.

Furthermore, the scenarios corresponding to the above described channels, provide a minimum and common set of communication and interaction services capable of allowing, to the participating users, to share the audio, the video images of other users and a virtual ambient on which for example hand-written notes or electronic data present at the own workstations can be picked up.

In FIG. 5 a block diagram is described, that represents a system architecture that carries out the method according to the invention. According to this architecture a user 20 comes into contact with a physic interface device 21, for example an haptic interface capable of being operated by the user 20 and of transmitting to the user returning signals, making a virtual environment in which the user has the sensation to be immersed. This interface device is connected to an interface agent 28 adapted to connect said interface physic device 21 with a network of connection 27. This interface agent 23 is capable of analysing signals corresponding to one or more sensorial perception channels of the user and, in particular, in the example described they are three: visual 28, haptic 29 and audio 30 channels. The components until now described, are resident in the local workstation where the user is located, but this position is operatively connected to one or more remote workstations that contain one or more services 26. Like for local workstation, also for services 26 an agent is provided that, in this case, is a service agent 24 adapted to communicate with said remote service 26. When the connection 27 has been created, the interface agent 23 and the service agent 24 communicate directly to each other in real time.

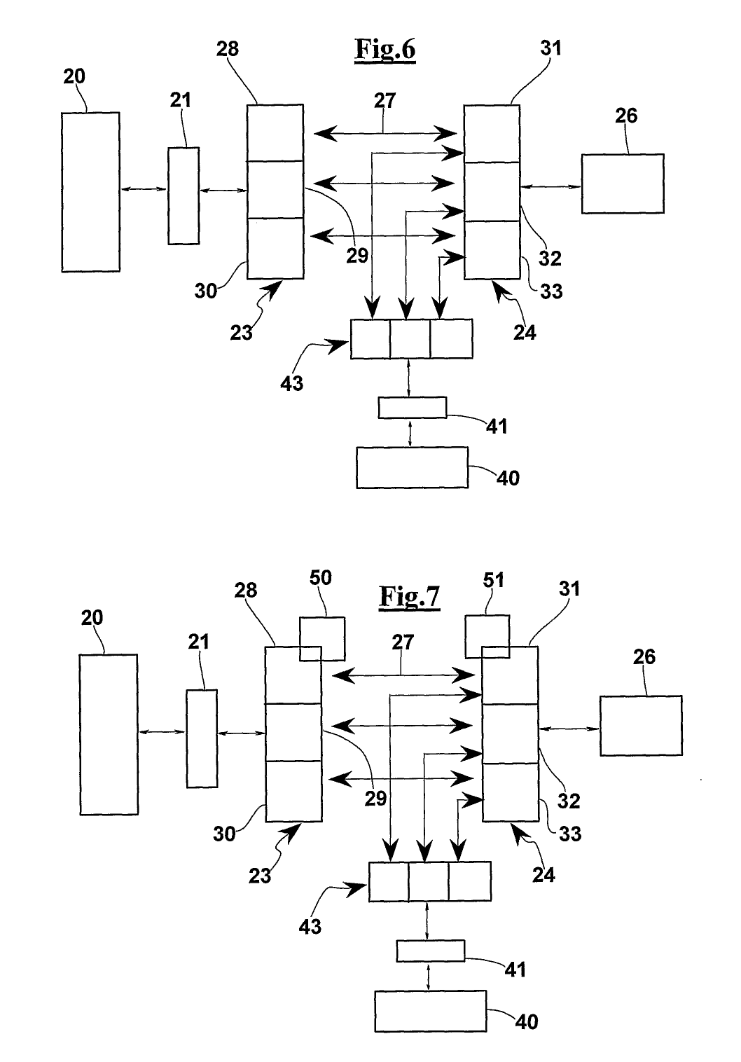

As shown in FIG. 6, also a second user 40, by a second haptic interface and by an interface agent 43, can connect to the same service 26, entering in the same virtual environment of the first user 20, with which he can cooperate.

A further implementation, shown in FIG. 7, comprises the possibility of generation of local models 50 and 51 which are more easily transmissible, by the interface agent and by the service agent.

A particular exemplary embodiment of the method according to the invention is operated by the following steps:
connection to the Web server through a Standard Client;
selection, from the user side, of the service in which to enter (following a link);
identification, through scripting, of the multisensorial hardware;
downloading the interface agent for controlling the systems and for displaying the virtual environment;
creating, on the server, an access to the required service (service agent);
automatic connection between the interface agents and the service agents, and activating a common immersive virtual environment in which all the users can cooperate with one another.

In FIG. 8 a three-dimensional schematic representation view is shown of a possible scenario of application of the method according to the invention, wherein two users 73 and 74 interact through a communication having three channels of perception for user, wherein the level 60 relates to the haptic channel of perception where two devices haptic 63 and 65 communicate to each other by a haptic coordinator 64, the level 61 relates to the visual channel of perception wherein two couples of visual devices 66 and 68 communicate to each other by a visual coordinator 67, while the level 62 relates to the audio channel of perception wherein two couples of audio devices 69 and 71 communicate to each other by an audio coordinator 70.

The above described service agent and interface agent are implementable by a skilled person. For their implementation is interesting, for example, the following.

The service agent and the interface agent should be interactively uploaded, for example a so called “applet”.

They should bring methods that have to be accessible to the network context. For example the protocols COM or ActiveX can be used, according to the Microsoft® standard.

The methods that the applet have to bring must comprise:
a. methods dedicated to manage the interface,
b. methods dedicated to support a network protocol.

The former methods have to be capable of implementing the multisensorial three channels, i.e. manage features of feedback force; detecting and generating acoustic stimuli, detecting visual data by an user, supporting the display in a virtual environment; the latter will be made through standard OpenGL or DirectX primitive for 3D visualization.

Concerning the latter methods, the streaming support has to be implemented with high performance channels without further latency like those caused by the Z-buffering.

To get round of the problems of absence of Z-buffering, the more critical services should provide local algorithms in order to stop the first sensory loop as near as possible to the final user, in order to generate possible force, audio, or visual feedback with the performance adapted to the request of service quality and, in particular, local sub-services (modeling environment, modeling of behaviour) can be shaped in order to give decisional autonomy if the feedback signal from the network is in delay or absent.

Concerning the environment of development of the agent, it is advisable to use software languages that do not introduce further latency in the calculus and then are adapted to the control of the performances (for example C++, XVR, Assembler).

The network protocols for supporting the streaming can be both for block delivering (UDP), more suitable for data of performances, and for ensured delivery (TCP), more suitable for to categories of data that require a control for completeness of the data exchanged (definition of the environment, carrying out a transaction).

The interface agent, when it is executed, should follow preferably the following operative flowchart:
1. identification of the Hardware devices of multisensorial type available at the remote position;
2. demand of the drivers for controlling said devices to service agent;
3. loading the operative scenario;
4. loading the possible model of behaviour;
5. instauration of the streaming channel for communication of the data flow;
6. activation of the rendering cycle composed by the following steps:
   a. acquisition of the input by the user (movements taken through haptic, optical, tracking)
   b. updating the local model of behaviour and transmission of the input to the remote position;
   c. acquisition (in asynchronous way) of the feedback of streaming by the remote location and further updating the local model;
   d. generating the data for rendering to the user;
   e. controlling of the devices for generating the data;
7. monitoring the network connections and possible closing of the account (shutdown of the devices in a sure ways, closing properly the channels of communication with the remote service).

The service agent should provide a complementary operative flow adapted to:
1. wait for a connection;
2. send possible software, drivers, models and other data required;
3. provide interactively streaming services (TCP, UDP) as required,
4. connect said services to the model of behaviour represented,
5. advantageously provide a multi-agent connection for cooperation of more users on a same service.

The foregoing description of a specific embodiment will so fully reveal the invention according to the conceptual point of view, so that others, by applying current knowledge, will be able to modify and/or adapt for various applications such an embodiment without further research and without parting from the invention, and it is therefore to be understood that such adaptations and modifications will have to be considered as equivalent to the specific embodiment. The means and the materials to realize the different functions described herein could have a different nature without, for this reason, departing from the field of the invention. It is to be understood that the phraseology or terminology employed herein is for the purpose of description and not of limitation.

1. A communication method between one or more users associated to respective workstations and one or more remote services even located in geographically different places, said workstations and said services being connectable by a communication network, comprising the steps of:
providing a remote service located in a Web server or distributed among more Web servers;
providing an interface device between said user and a relative local workstation;
connecting said local workstation with said or each Web server through a communication network;
characterized in that said step of connecting comprises the steps of:
creating on said or each Web server an interface agent between said device and the communication network, said interface agent computing signals corresponding to sensorial perception channels of the user comprising the haptic, visual and audio channels;
uploading said interface agent in said local workstation;
creating on said or each Web server a service agent adapted to connect said service with said communication network, said service agent computing signals corresponding to sensorial perception channels of the user comprising the haptic, visual and audio channels;
connecting in an automatic and direct way said interface agent and said service agent and activating a common immersive virtual environment in which said or each user can work.

2. A communication method, according to claim 1, wherein said haptic channel provides to the user a signal with frequency not less than 1 kHz.

3. A communication method, according to claim 1, wherein said visual channel provides to the user a signal with frequency not less than 20 Hz.

4. A communication method, according to claim 1, wherein said interface device is capable of providing to the user data of afferent and/or efferent type.

5. A communication method, according to claim 1, wherein said service agent and said interface agent are capable of generating a respective model of local behaviour directly transmissible in real time between said agents through said connection.

6. A communication method, according to claim 1, wherein said communication network comprises connecting means selected from the group comprised of:
cable;
air;
satellite.

7. A communication method, according to claim 1, wherein said services comprise a software capable of generating digital data relative to said sensorial perception channels, said services being selected from the group comprised of:
solid and/or geometric modeling;
interaction with stiff or deformable physical objects;
modeling mechanisms and mechanical behaviours;
modeling physical phenomena such as field forces of electric, magnetic, chemical fields.
modeling/reproducing processes consisting of simple or articulated sequences of motion and procedures.
remote training courses.

8. A system architecture for communication between one or more users associated to respective workstations and one or more remote services even located in geographically different places, comprising:
a physical interface device between said user and said local workstation;
connecting means;
an interface agent adapted to connect said physical interface device with said connection means;
a remote service agent adapted to connect said remote service with said connection means;
whereby a direct connection is operatively established between said remote service agent and said interface agent, adapted to act in real time and to create a common immersive virtual environment to said users where said services are available and where said users can cooperate in real time.
